(19) United States
(12) Patent Application Publication
(10) Pub. No.: US 2004/0078773 A1
(43) Pub. Date: Apr. 22, 2004

(54) Template based clock routing and balancing

(75) Inventors: Harsh Sharma, Austin, TX (US); Shervin Hojat, Austin, TX (US); David Hogenmiller, Cedar Park, TX (US)

Correspondence Address: Philip J. McKay, Gunnison, McKay & Hodgson, L.L.P., Suite 220, 1900 Garden Road, Monterey, CA, 93940, US

(73) Assignee: Sun Microsystems, Inc.

(21) Appl. No.: 10/277,267

(22) Filed: Oct. 21, 2002

(51) Int. Cl. G06F 17/50

(52) U.S. Cl. 716/13; 716/14

(57) ABSTRACT

Predetermined and standardized path templates are introduced between points and/or elements in an integrated circuit layout. According to one embodiment of the invention, the standardized path templates are made up of two or more parallel tracks of path segments, with or without corresponding perpendicular path segments. According to the invention, the path segments are connected as needed to form serpentine or non-serpentine paths of the required length.

### FIELD OF THE INVENTION

The present invention is directed to the field of electronic component design and, more particularly, to methods for standardizing the minimization of clock skew in microprocessor design.

### BACKGROUND OF THE INVENTION

For the present, virtually all mainstream electronic components and systems, such as microprocessors, are synchronous systems employing one or more system clocks that act as the driving force or “heart” of the electronic system. As a result, more often than not, it is critical that a given system clock signal arrive at various points in the system at nearly the same time. As discussed below, this situation can create a significant complication.

FIG. 1A shows a typical length of wire 100 including, from left to right, in the direction shown by arrow 102, points 101, 103 and 105. As is well known, the physics of conductors and wave propagation dictate two important facts: first, the absolute speed limit for any signal moving from point 101 to points 103 or 105 is the speed of light; second, since wire 100 is typically a metallic conductor, with an inherent resistance, a signal propagating in wire 100 will actually travel at a speed significantly less than the speed of light.

As a result of these physical limitations on the speed at which a signal can propagate through wire 100, it follows that the greater the distance between two points on/in wire 100, the longer it takes the signal to reach the point. Consequently, a signal traveling from point 101, in the direction shown by arrow 102, will take less time to reach point 103, i.e., travel distance 107, than it will take to reach point 105, i.e., travel distance 107 and distance 109, and there is a time delay between when the signal reaches point 103 and when it reaches point 105. In addition, as can be seen from the discussion above, as long as wire 100 has a reasonably consistent composition and the wire lies on the same metal layer, the time delay is typically proportional to the distance traveled, i.e., twice the distance results in approximately four times the delay.

As mentioned above, in a typical microprocessor, a given system clock signal arrives at one or more pins located around the periphery of the microprocessor chip. In addition, there are typically numerous points, located at different distances from the periphery of the chip and the clock pins, which must receive the clock signal at the same time. Given the discussion above with respect to FIG.1, it can be understood that the problem of ensuring a given clock signal received at a first point arrives, nearly simultaneously, at various other points, at various distances from the first point, and connected to the first point by differing length wires, such as wire 100, is significant.

The introduction of a time delay, also called simply a “delay”, between when one point receives a clock signal and when a second point, that should receive the clock signal at the same time, actually receives the clock signal is known as clock skew. Consequently, the ideal system has a zero clock skew. If clock skew becomes too large, the system, at a minimum, will operate inefficiently, typically slower. In addition, if the clock skew is more extreme, the system architecture will not provide enough useful cycle time for a given frequency. This, in turn, will cause the system to run slower or can cause an undesirable signal to win a race condition, thereby creating a defective chip and a system failure.

As clock speeds become faster and faster, and more operations are required per clock, the problem of clock skew becomes even more pronounced and the margin for error is further reduced. However, this problem is not new and several mechanisms are in wide use in the art to reduce the clock skew problem including using multiple clock inputs, using multiple clock signals, and introducing delays between points to slow down the signal between close points so the more distant points receive the signal at the same time as the close points.

FIG. 1B is a simplified representation of a first point, point A, which receives, and then relays, a system clock signal. For the purposes of this example, it is assumed that the clock signal must be relayed to two points, point B and point C, at nearly the same time. Also shown in FIG. 1B is circuit element 157 at point D. Circuit element 157 is representative of any circuit element such as a buffer, junction, gate etc.

Since, as shown in FIG. 1B, the distance between point A and point B, along path 159, is less than the distance between point A and point C, along path 158, some mechanism for introducing a delay of the clock signal along path 159 must be introduced to ensure the clock signal arrives at points B and C at the same time. One common prior art mechanism for introducing a delay of the clock signal along path 159, to ensure the clock signal arrives at points B and C at the same time, is to manually create artificial additional length of path 159.

FIG. 1C shows one example of a prior art method for manually artificially lengthening path 159 by what is commonly called manually “serpentineing” path 159 with jogs 151, 153 and 155 to create path 159A. The addition of jogs 151, 153 and 155 makes path 159A as long as path 158 and therefore introduces the delay required to ensure the clock signal arrives at points B and C at the same time.

The prior art manual serpentine method of FIG. 1B worked adequately well in a static situation, i.e., when loads on points B and C remained constant and the location of points A, B and C remained constant. However, as those of skill in the art of integrated circuit design are well aware, the process of designing a chip and its layout is far from static and is subject to constant modification at every level of the design process.

As a very simple example, FIG. 1D illustrates a situation where, for one of numerous possible design reasons, point C must be moved to a new location point C′. Since point C′ is further from point A then was point C, additional jogs 156, 159, 161, 163, and 165 must be added to jogs 151, 153 and 155 of path 159A to create path 159B with a length equal to path 158′ between point A and point C′.

This solution using the prior art manual serpentine method seems simple enough until one realizes that, due to the very limited space in a circuit layout, the addition of jogs 156, 159, 161, 163, and 165 means that, in some cases, circuit element 157 may have to be moved from point D to point D′ to make room for jogs 156, 159, 161, 163, and 165. In addition, in most instances, circuit element 157 is also coupled to a system clock, or other signal, by its own wire path (not shown). Consequently, the situation is further complicated by the movement and change in this path and any change in circuit element 157's path can easily result in further down-line modifications. It is easy to visualize that this situation propagates through the entire chip layout and, even in this simplest example, using prior art manual serpentine methods, it can be seen that a single modification and addition of jogs 156, 159, 161, 163, and 165 can cause considerable modification and consideration design cycles.

In a typically microprocessor design, the system layout can easily change numerous times as load values and element locations are changed to meet the needs of the microprocessor architecture or to accommodate unexpected results or new feature sizes. To accommodate the limitation of prior art manual serpentine methods, the circuit designers often over planned and reserved excess space and resources early on in the process so those resources could be available, if needed. This often resulted in a waste of resources and, to make matters worse, the wasted resources were often desperately needed by other functions in the circuit design process. On the other hand, if not enough resources were reserved, it becomes much more difficult, if not impossible, to get additional resources later on in the design process. In addition, the custom made and haphazard nature and application of prior art manual serpentine methods, virtually guaranteed that these methods could not be standardized or automated.

What is needed is a more predictable and readily automated method of varying the length of a path between two points in an integrated circuit during the design phase to minimize clock skew and standardize clock distribution methods.

### SUMMARY OF THE INVENTION

According to the invention, at the beginning of the design process, predetermined and standardized path templates are introduced between points and/or elements in an integrated circuit layout. According to one embodiment of the invention, the standardized path templates are made up of two or more parallel tracks of path segments, with or without corresponding perpendicular path segments. According to one embodiment of the invention, each path segment is a known length and width and therefore has a known and predictable delay time and physical properties. According to the invention, the path segments are connected as needed to form serpentine or non-serpentine paths of the required length. According to the invention, if no serpentine path is required, path segments are simply connected linearly and any unused path segments are utilized for wire shielding. If serpentine paths are required, or are later needed, according to the method of the invention, the path segments are already in place and these path segments are simply connected in the manner needed to supply the required length.

Unlike the prior art manual methods described above, using the methods of the present invention, there is little or no guess work in creating a serpentine path and design changes are readily accommodated by pre-allocated and standardized resources. Consequently, as load values and element locations are changed in the integrated circuit to meet the needs of the architecture, or to accommodate unexpected results or new feature sizes, the method of the present invention provides a prefabricated and easily implemented design re-work mechanism.

In addition, unlike the prior art manual methods described above, using the methods of the present invention, the circuit designers do not need to over plan and reserve excess space and resources. Consequently, resources are more available and are more efficiently used.

In addition, unlike the custom made and haphazard prior art manual serpentine methods, the method of the invention is patterned around predetermined and standardized path templates that are made of path segments with known length and width and therefore known and predictable delay time and physical properties. Consequently, the method of the present invention is particularly suited to automation.

As noted above, in a typically microprocessor design, the system layout can easily change numerous times. Consequently, the method of the present invention represents a significant improvement in integrated circuit design that can result in dramatic improvements in efficiency and time to market.

It is to be understood that both the foregoing general description and following detailed description are intended only to exemplify and explain the invention as claimed.

### BRIEF DESCRIPTION OF THE DRAWINGS

The accompanying drawings, which are incorporated in, and constitute a part of this specification, illustrate embodiments of the invention and, together with the description, serve to explain the advantages and principles of the invention. In the drawings:

FIG. 1A shows a typical length of wire;

FIG. 1B is a simplified representation of a first point, point A, which receives, and then relays, a system clock signal to two points, point B and point C;

FIG. 1C shows one example of a prior art method for manually artificially lengthening a path by what is commonly called manually “serpentineing” the path;

FIG. 1D illustrates a situation where, for one of numerous possible design reasons, a point C must be moved to a new location point C′.

FIG. 2A shows a simplified representation of a standardized path template between point A and point B in accordance with one embodiment of the present invention;

FIG. 2B shows a simplified representation of a first point, point A, which receives, and then relays, a system clock signal, and path template portions in accordance with one embodiment of the present invention;

FIG. 3A shows one example of how, according to one embodiment of the present invention, path template portions of the invention are used to introduce the required delay between point A and point B along a path;

FIG. 3B illustrates a situation where, for one of numerous possible design reasons, point C in FIG. 3A must be moved to a new location point C′ in FIG. 3B and, according to one embodiment of the present invention, path template portions of the invention are used to introduce the required new delay between point A and point B along a path;

FIG. 4 shows another path template in accordance with one embodiment of the present invention;

FIG. 5 shows another path template in accordance with one embodiment of the present invention.

### DETAILED DESCRIPTION

The invention will now be described in reference to the accompanying drawings. The same reference numbers may be used throughout the drawings and the following description to refer to the same or like parts.

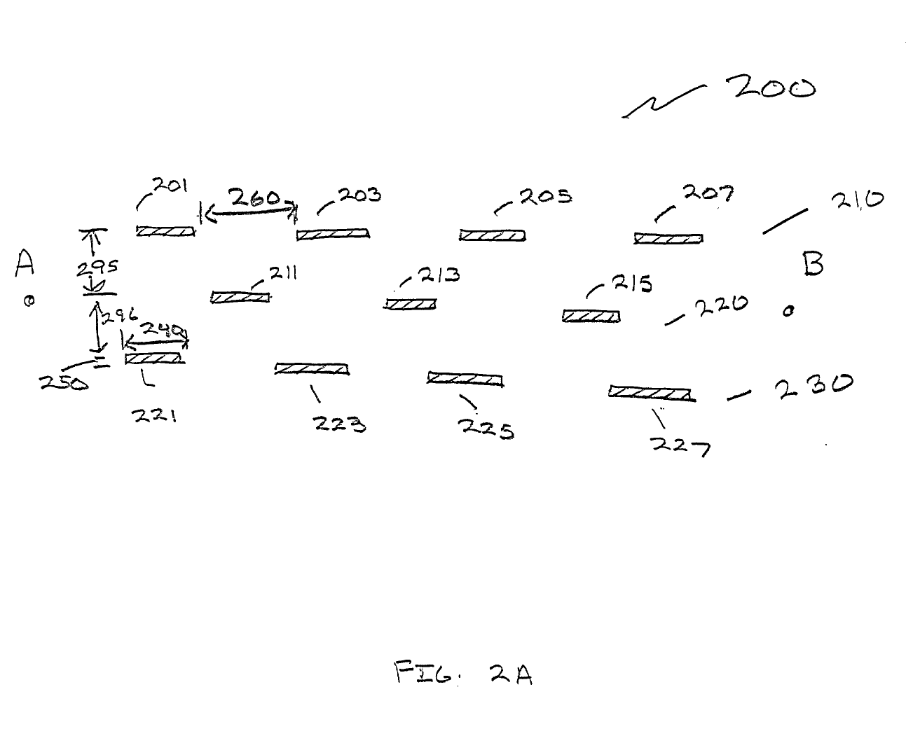

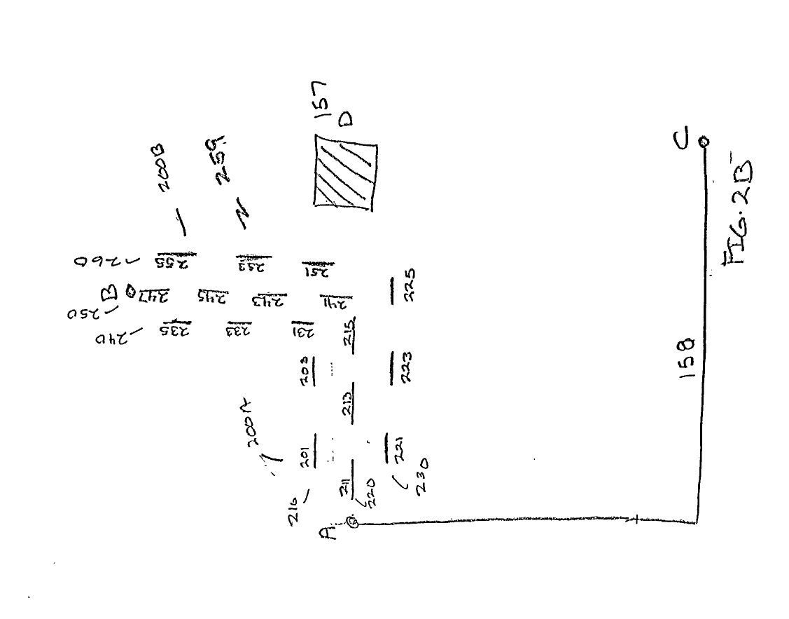

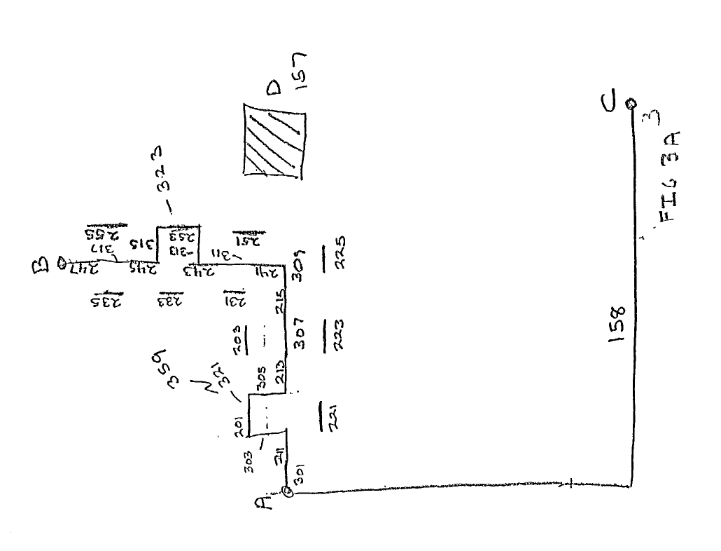

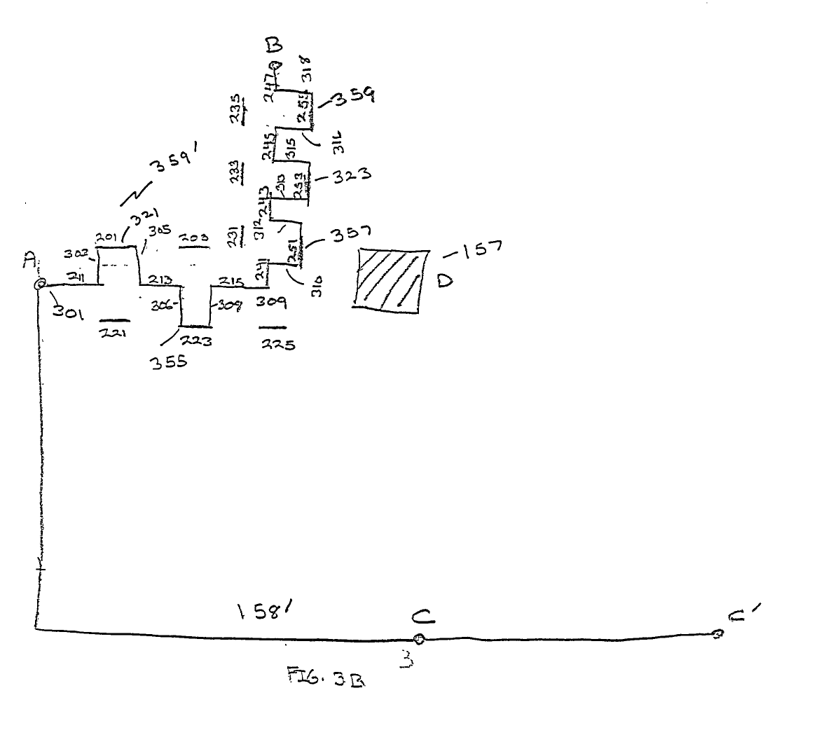

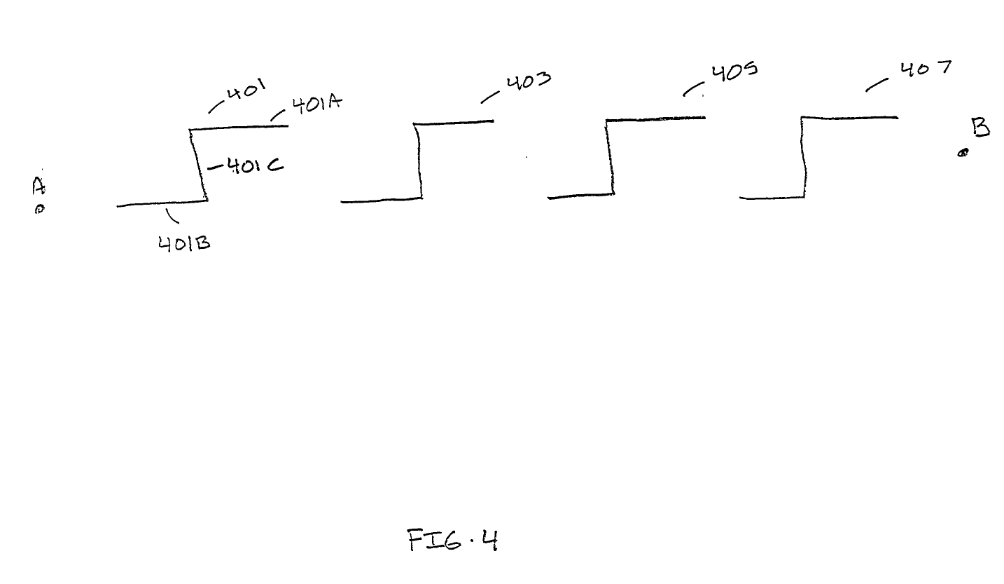

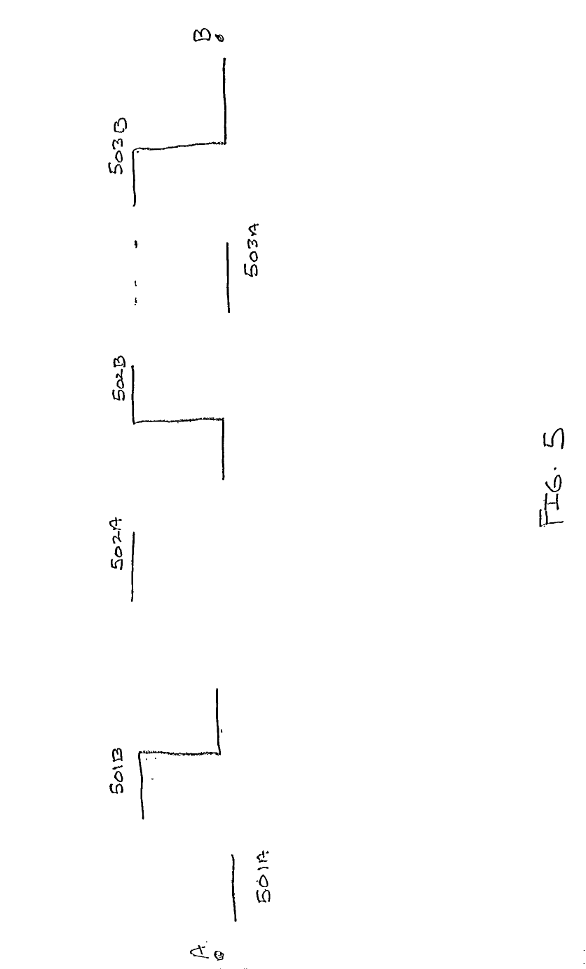

According to the invention, at the beginning of the design process, predetermined and standardized path templates (200 in FIG. 2A, 259 in FIG. 2B, 400 in FIG. 4 and 500 in FIG. 5) are introduced between points (A, B, C, D in FIGS. 2A, 2B, 3A, 3B) and/or elements D in FIGS. 2A, 2B, 3A and 3B) in an integrated circuit layout. According to one embodiment of the invention, the standardized path templates are made up of two or more parallel tracks (210, 220, and 230 in FIG. 2A) of path segments (201, 203, 205, 207, 211, 213, 215, 221, 223, 225, and 227 in FIG. 2A), with or without corresponding perpendicular path segments. According to one embodiment of the invention, each path segment is a known length (240 in FIG. 2A) and width (250 in FIG. 2A) and therefore has a known and predictable delay time and physical properties. According to the invention, the path segments are connected as needed to form serpentine or non-serpentine paths of the required length. According to the invention, if no serpentine path is required, path segments are simply connected linearly and any unused path segments are utilized for wire shielding. If serpentine paths are required, or are later needed, according to the method of the invention, the path segments are already in place and these path segments are simply connected in the manner needed to supply the required length (359 in FIG. 3B and 259′ in FIG. 3B).

Unlike the prior art manual methods described above, using the methods of the present invention, there is little or no guess work in creating a serpentine path and design changes are readily accommodated by pre-allocated and standardized resources. Consequently, as load values and element locations are changed in the integrated circuit to meet the needs of the architecture, or to accommodate unexpected results or new feature sizes, the method of the present invention provides a prefabricated and easily implemented design re-work mechanism.

In addition, unlike the prior art manual methods described above, using the methods of the present invention, there is no need to over plan and reserve excess space and resources. Consequently, resources are more available and are more efficiently used.

In addition, unlike the custom made and haphazard prior art manual serpentine methods, the method of the invention is patterned around predetermined and standardized path templates that are made of path segments with known length and width and therefore known and predictable delay time and physical properties. Consequently, the method of the present invention is particularly suited to automation.

FIG. 2A shows a standardized path template 200 between point A and point B implemented according to the method of the invention. As shown in FIG. 2A, path template 200 is made up of path segments 201, 203, 205, 207, 211, 213, 215, 221, 223, 225, and 227 arranged in parallel tracks 210, 220, and 230. According to one embodiment of the invention, path segments 201, 203, 205, 207, 211, 213, 215, 221, 223, 225, and 227 all have the same length 240 and width 250. Consequently, each path segment 201, 203, 205, 207, 211, 213, 215, 221, 223, 225, and 227 has almost identical properties in terms of resistance, capacitance reactance etc.

In one embodiment of the invention, path segments 201, 203, 205, and 207 are separated one from the next from by a distance 260 along track 210. In one embodiment of the invention, distance 260 is equal to length 240 of path segments 201, 203, 205, 207, 211, 213, 215, 221, 223, 225, and 227. In one embodiment of the invention, path segments 211, 213 and 215 are separated one from the next from by a distance 260 along track 220. In one embodiment of the invention, path segments 221, 223, 225 and 227 are separated one from the next from by a distance 260 along track 230. In one embodiment of the invention, track 220 is separated from track 210 by distance 295 and track 230 is separated from track 220 by distance 296.

Path segments 201, 203, 205, 207, 211, 213, 215, 221, 223, 225, and 227 are eventually made of conductive material, such as a metal. According to the method of the invention, path template 200 is inserted between point A and point B at the beginning of the design process. As discussed in more detail below, path segments 201, 203, 205, 207, 211, 213, 215, 221, 223, 225, and 227 are then connected as needed to form serpentine or non-serpentine paths of the required length. According to the invention, if no serpentine path is required, co-linear path segments, such as: path segments 201, 203, 205 and 207 along track 210; path segments 211, 213, 215 on track 220; or path segments 221, 223, 225 and 227 on track 230 are simply connected linearly and any unused path segments are utilized for wire shielding. If serpentine paths are required, or are later needed, according to the method of the invention, path segments 201, 203, 205, 207, 211, 213, 215, 221, 223, 225, and 227 are already in place and these path segments are simply connected in the manner needed to supply the required length.

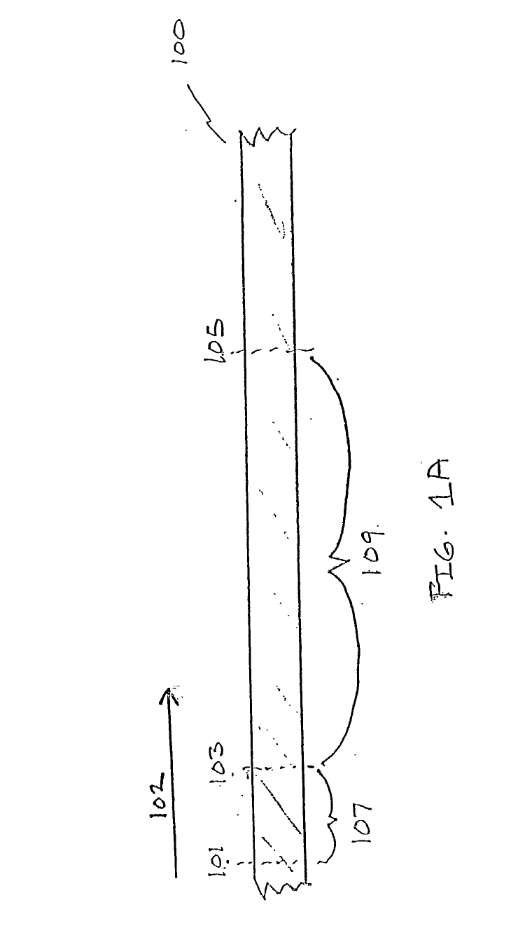

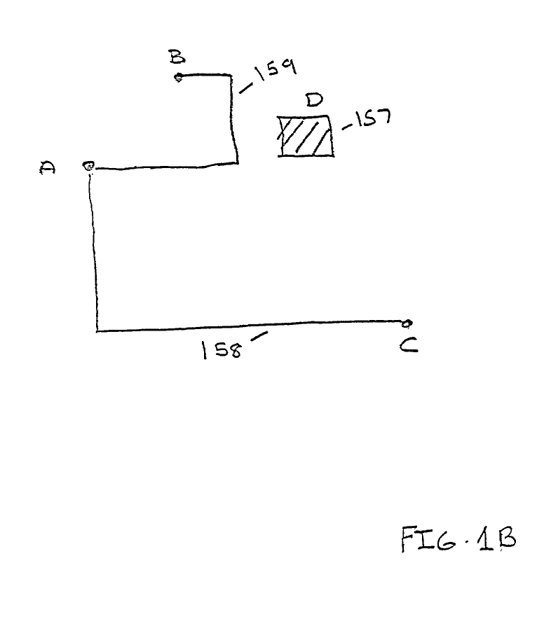

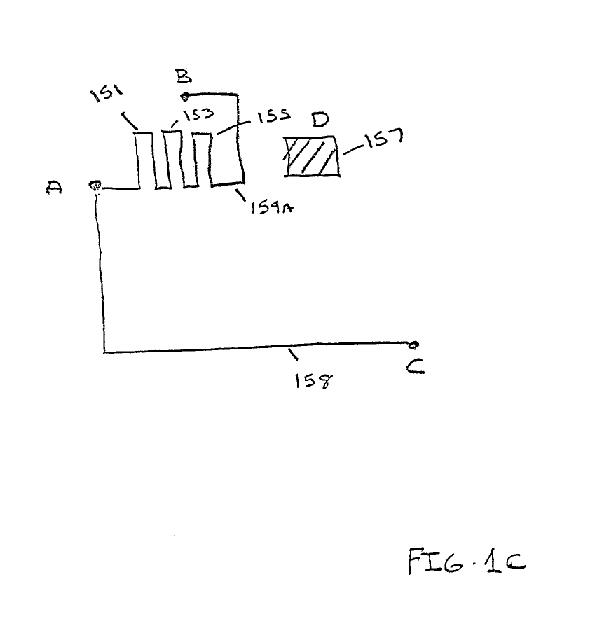

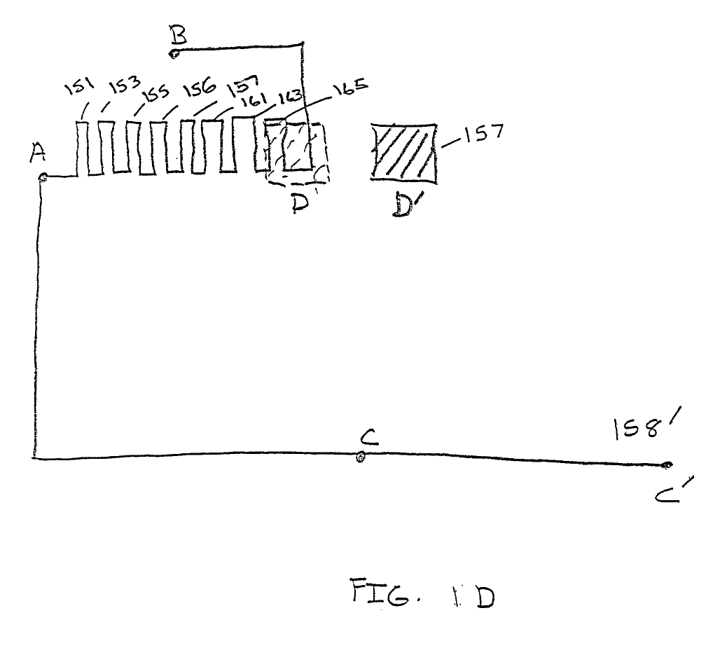

FIG. 2B is similar to FIG. 1B, discussed above, and shows a simplified representation of a first point, point A, which receives, and then relays, a system clock signal. For the purposes of this example, it is assumed that the clock signal must be relayed to two points, point B and point C, at nearly the same time. Also shown in FIG. 2B is circuit element 157 at point D. Circuit element 157 is representative of any circuit element such as a buffer, junction, gate etc.

As shown in FIG. 2B, according to the invention, two path template portions 200A and 200B, each similar to path template 200 of FIG. 2A, connect point A and point B. Path template portion 200A includes: path segments 201 and 203 on track 210; path segments 211, 213, and 215 along track 220; and path segments 221, 223 and 225 along track 230. Path template portion 200B includes: path segments 231, 233, and 235 on track 240; path segments 241, 243, 245, and 247, along track 250; and path segments 251, 253 and 255 along track 260. According to the invention, path template portions 200A and 200B are inserted into the design plan early on in the design process.

Since, as shown in FIG. 2B, the distance between point A and point B, along path 259, is less than the distance between point A and point C, along path 158, some mechanism for introducing a delay of the clock signal along path 259 must be introduced to ensure the clock signal arrives at points B and C at the same time. FIG. 3A shows one example of how, according to the present invention, path template portions 200A and 200B are used to introduce the required delay between point A and point B along path 359. As shown in FIG. 3A, point A is connected to path segment 211 by connecting segment 301. In addition, according to the invention, jog 303 is created in path 359 by connecting path segment 211 to path segment 201 with connecting segment 303 and connecting path segment 201 to path segment 213 with connecting segment 305. Path segment 213 is then linearly connected to path segment 215 with connecting segment 307 and path segment 215 is connected to path segment 241 by connecting segment 309. Path segment 241 is linearly connected to path segment 243 by connecting segment 311. In addition, jog 323 is created by connecting path segment 243 to path segment 253 with connecting segment 313 and path segment 253 with path segment 245 with connecting segment 315. Path segment 245 is linearly connected to path segment 247, and point B, by connecting segment 317. As a result, according to the invention, a serpentine path 359 between point A and point B, of length equal to the length of path 158, between point A and point C, is created by connecting pre-positioned uniform segments 301, 211, 303, 201, 305, 213, 307, 215, 309, 241, 311, 243, 313, 253, 315, 245, 317 and 247.

As seen above, using the method of the invention, path 359 is created easily from uniform building blocks in the form of path segments 301, 211, 303, 201, 305, 213, 307, 215, 309, 241, 311, 243, 313, 253, 315, 245, 317 and 247. Consequently, path 359 has known physical properties and no major re-work of the circuit layout is required. The ease of creation of path 359, and the easily determined properties of path 359, using the method of the invention, is a vast improvement over the haphazard and customized prior art methods. However, the advantages of the method of the invention are even more pronounced when design changes are required.

As noted above, in a typically microprocessor design, the system layout can easily change 30, 40, 50 or more times in the course of a design implementation. As a very simple example, FIG. 3B illustrates a situation where, for one of numerous possible design reasons, point C in FIG. 3A must be moved to a new location point C′ in FIG. 3B. Since point C′ is further from point A then was point C, additional delay must be added to path 359 of FIG. 3A to create path 359′ in FIG. 3B with a length equal to path 158′ between point A and point C′. As shown in FIG. 3B, and discussed in more detail below, using the method of the invention, this additional delay is provided easily and without the need for moving circuit element 157.

To provide the additional delay for path 359′ jogs 355, 357 and 359 are added to jogs 321 and 323 of path 359 (FIG. 3A). Consequently, the new path 359′ is created, according to the invention, as follows: point A is connected to path segment 211 by connecting segment 301. Jog 303 is created in path 359′ by connecting path segment 211 to path segment 201 with connecting segment 303 and connecting path segment 201 to path segment 213 with connecting segment 305. Jog 355 is created by connecting path segment 213 to path segment 223 with connecting segment 306 and connecting path segment 223 to path segment 215 with connecting segment 308. Path segment 215 is connected to path segment 241 by connecting segment 309. Jog 357 is created by connecting path segment 241 to path segment 251 with connecting segment 310 and connecting path segment 251 to path segment 243 with connecting segment 312. Jog 323 is created by connecting path segment 243 to path segment 253 with connecting segment 313 and path segment 253 with path segment 245 with connecting segment 315. Jog 359 is created by connecting path segment 245 to path segment 255 with connecting segment 316 and connecting path segment 255 to path segment 247, and point B, with connecting segment 318.

Since, according to the invention, path template portions 200A and 200B are already in place, with the capability to add jogs, such as jogs 355, 357 and 359, as needed, the additional delay necessitated by design changes, such as the movement of point C to point C′, is easily accommodated and no major rework is required, In addition, there is no need to move circuit element 157 as was required using the prior art methods (see FIGS. 1C and 1D).

As discussed above, unlike the prior art manual methods described above, using the methods of the present invention, there is little or no guess work in creating a serpentine path, such as paths 359 and 359′, and design changes are readily accommodated by pre-allocated and standardized resources. Consequently, as load values and element locations are changed in the integrated circuit to meet the needs of the architecture, or to accommodate unexpected results or new feature sizes, the method of the present invention provides a prefabricated and easily implemented design re-work mechanism.

In addition, unlike the prior art manual methods described above, using the methods of the present invention, the circuit designers do not need to over plan and reserve excess space and resources. Consequently, resources are more available and are more efficiently used.

In addition, unlike the custom made and haphazard prior art manual serpentine methods, the method of the invention is patterned around predetermined and standardized path templates that are made of path segments with known length and width and therefore known and predictable delay time and physical properties. Consequently, the method of the present invention is particularly suited to automation.

Those of skill in the art will readily recognize that several modifications can be made to the path templates of the invention and the pattern of the path templates can be varied to suit the specific needs of the designer and the application. FIG. 4 shows another relatively simple path template 400 designed for use in accordance with the present invention. Path template 400 includes step shaped path segments 401, 403, 405, and 407 with horizontal components, such as horizontal components 401A and 401B, and vertical, or perpendicular components, such as vertical component 401C.

FIG. 5 shows a path template 500 with a more complicated pattern consisting of: left step segments 501B and 503B; right step segment 502B and horizontal segments 501A and 503A. Those of skill in the art will readily recognize that there are an infinite number of possible patterns for path templates suitable for use according to the invention and that the specific patterns shown in FIGS. 2A, 2B, 3A, 3B, 4 and 5 above are set forth for illustrative purposes only and the present invention is not to be limited to these specific, illustrative, examples.

As noted above, in a typically microprocessor design, the system layout can easily change 30, 40 or 50 or more times. Consequently, the method of the present invention represents a significant improvement in integrated circuit design that can result in dramatic improvements in efficiency and time to market.

The foregoing description of an implementation of the invention has been presented for purposes of illustration and description only, and therefore is not exhaustive and does not limit the invention to the precise form disclosed. Modifications and variations are possible in light of the above teachings or may be acquired from practicing the invention.

What is claimed is:

1. A method for routing signals in the design of an integrated circuit, said method comprising:
providing a signal to a first point in an integrated circuit;
designating a second point in said integrated circuit, said second point to be coupled to said first point in said integrated circuit;
providing a path template between said first point and said second point in said integrated circuit, said path template comprising a plurality of path segments arranged in a pattern; and
connecting at least two of said plurality of said path segments in said path template such that said first point is coupled to said second point by connected path segments, wherein;
a signal traveling from said first point to said second point is delayed a predetermined time.

2. The method for routing signals in the design of an integrated circuit of claim 1, wherein:
said plurality of path segments of said path template are arranged in two parallel tracks.

3. The method for routing signals in the design of an integrated circuit of claim 1, wherein:
said plurality of path segments of said path template are arranged in three parallel tracks.

4. The method for routing signals in the design of an integrated circuit of claim 1, wherein:
said plurality of path segments of said path template are arranged in four or more parallel tracks.

5. The method for routing signals in the design of an integrated circuit of claim 1, wherein:
said plurality of path segments of said path template comprise linear path segments.

6. The method for routing signals in the design of an integrated circuit of claim 5, wherein:
said plurality of path segments of said path template are arranged in two parallel tracks.

7. The method for routing signals in the design of an integrated circuit of claim 5, wherein:
said plurality of path segments of said path template are arranged in three parallel tracks.

8. The method for routing signals in the design of an integrated circuit of claim 5, wherein:
said plurality of path segments of said path template are arranged in four or more parallel tracks.

9. The method for routing signals in the design of an integrated circuit of claim 1, wherein:
said plurality of path segments of said path template comprise step path segments.

10. The method for routing signals in the design of an integrated circuit of claim 9, wherein:
said plurality of path segments of said path template are arranged in two parallel tracks.

11. The method for routing signals in the design of an integrated circuit of claim 9, wherein:
said plurality of path segments of said path template are arranged in three parallel tracks.

12. The method for routing signals in the design of an integrated circuit of claim 9, wherein:
said plurality of path segments of said path template are arranged in four or more parallel tracks.

13. The method for routing signals in the design of an integrated circuit of claim 1, further comprising:
designating a third point in said integrated circuit, said third point to be coupled to said first point in said integrated circuit;
providing a path template between said first point and said third point in said integrated circuit, said path template comprising a plurality of path segments arranged in a pattern;
connecting at least two of said plurality of said path segments in said path template such that said first point is coupled to said third point by connected path segments and such that a signal traveling from said first point to said third point is delayed a predetermined time.

14. The method for routing signals in the design of an integrated circuit of claim 13, wherein:
said plurality of path segments of said path template are arranged in two parallel tracks.

15. The method for routing signals in the design of an integrated circuit of claim 13, wherein:
said plurality of path segments of said path template are arranged in three parallel tracks.

16. The method for routing signals in the design of an integrated circuit of claim 13, wherein:
said plurality of path segments of said path template are arranged in four or more parallel tracks.

17. An integrated circuit design comprising:
a signal coupled to a first point in an integrated circuit;
a second point in said integrated circuit; and,
a path template positioned between said first point and said second point in said integrated circuit, said path template comprising a plurality of path segments arranged in a pattern, wherein;
at least two of said plurality of said path segments in said path template are connected such that said first point is coupled to said second point by connected path segments.

18. The integrated circuit design of claim 17, wherein:
said plurality of path segments of said path template are arranged in two parallel tracks.

19. The integrated circuit design of claim 17, wherein:
said plurality of path segments of said path template are arranged in three parallel tracks.

20. The integrated circuit design of claim 17, wherein:
said plurality of path segments of said path template are arranged in four or more parallel tracks.
